(19) United States
(12) Patent Application Publication
(10) Pub. No.: US 2024/0229518 A1
(43) Pub. Date: Jul. 11, 2024

(54) CLOSURE LATCH ASSEMBLY WITH LATCH MECHANISM HAVING RATCHET/PAWL BYPASS PREVENTION

(71) Applicant: MAGNA CLOSURES INC., Newmarket (CA)

(72) Inventor: Marco TAURASI, Livorno (IT)

(21) Appl. No.: 18/544,424

(22) Filed: Dec. 18, 2023

Related U.S. Application Data
(60) Provisional application No. 63/437,796, filed on Jan. 9, 2023.

(51) Int. Cl. E05B 77/04

(52) U.S. Cl. CPC E05B 77/04

(57) ABSTRACT

A latch assembly a method resists inadvertent movement from a latched state to an unlatched state in a crash condition. Latch assembly includes a strength plate unit, with a ratchet supported by the strength plate unit for pivotal movement within a ratchet pivot plane between a striker release position and a striker capture position. A pawl is supported by the strength plate unit for pivotal movement within a pawl pivot plane between a ratchet holding position, whereat the pawl holds the ratchet in the striker capture position, and a ratchet releasing position, whereat the pawl permits pivotal movement of the ratchet within the ratchet pivot plane to the striker release position. The strength plate unit prevents movement of at least one of the ratchet out of the ratchet pivot plane and the pawl out of the pawl pivot plane while the pawl is in the ratchet holding position.

### CROSS-REFERENCE TO RELATED APPLICATION

This application claims the benefit of U.S. Provisional Application Ser. No. 63/437,796, filed Jan. 9, 2023, which is incorporated herein by way of reference in its entirety.

### FIELD

The present disclosure relates generally to vehicle latches. More particularly, this disclosure is directed to a closure latch assembly equipped with a ratchet/pawl type latch mechanism and a bypass prevention feature configured to inhibit non-normal movement of the ratchet and/or pawl during a crash.

### BACKGROUND

During a vehicle crash, the high force applied to the closure latch assembly could deform a strength plate unit, including the frameplate, whereupon a pawl of a latch mechanism could be moved to by-pass a ratchet, or vice versa, thereby reducing the resistance against the inadvertent closure latch assembly release from a latched state to an unlatched state, thereby allowing the door to open unexpectedly.

There is thus a need to provide a closure latch assembly having an arrangement configured to improve resistance against unintended release of the latch mechanism to an unlatched state during a crash event.

### SUMMARY

It is an object of the present disclosure to provide a door module that embodies the inventive concepts set forth in the following written disclosure and illustrations.

It is a further object of the present disclosure to prevent latch from inadvertently moving out from a latched state during a crash condition.

It is a further object of the present disclosure to prevent a pawl from moving out of a pawl pivot plane while the pawl is in a ratchet holding position.

It is a further object of the present disclosure to prevent a ratchet from moving out of a ratchet pivot plane while the pawl is in the ratchet holding position.

It is a further object of the present disclosure to simultaneously prevent the pawl from moving out of the pawl pivot plane and the ratchet from moving out of the ratchet pivot plane while the pawl is in the ratchet holding position.

In accordance with these and other objects of the disclosure, a closure latch assembly for a vehicle is provided. The closure latch assembly includes a strength plate unit, with a ratchet supported by the strength plate unit for pivotal movement about a ratchet pin within a ratchet pivot plane between a striker release position, whereat the ratchet is positioned to release a striker, and a striker capture position, whereat the ratchet is positioned to retain the striker, with the ratchet being biased toward the striker release position. A pawl is supported by the strength plate unit for pivotal movement about a pawl pin within a pawl pivot plane between a ratchet holding position, whereat the pawl is positioned to hold the ratchet in the striker capture position, and a ratchet releasing position, whereat the pawl is located to permit pivotal movement of the ratchet within the ratchet pivot plane to the striker release position, wherein the pawl is biased toward the ratchet holding position. The strength plate unit prevents movement of at least one of the ratchet out of the ratchet pivot plane and the pawl out of the pawl pivot plane while the pawl is in the ratchet holding position.

In accordance with another aspect of the disclosure, the strength plate unit has a bypass feature positioned adjacent at least one of the pawl pivot plane and the ratchet pivot plane. The bypass feature prevents at least one of the ratchet from moving out of the ratchet pivot plane and the pawl from moving out of the pawl pivot plane while the pawl is in the ratchet holding position.

In accordance with another aspect of the disclosure, the strength plate unit includes a frameplate and a backplate, wherein the ratchet and the pawl are supported for pivotal movement between the frameplate and the backplate, and the bypass feature is formed extending generally toward the ratchet and the pawl from at least one of the frameplate and the backplate.

In accordance with another aspect of the disclosure, the bypass feature is formed as a monolithic piece of material with at least one of the frameplate and the backplate.

In accordance with another aspect of the disclosure, the bypass feature is formed as a bent piece of material of at least one of the frameplate and the backplate.

In accordance with another aspect of the disclosure, the bypass feature is fixed to and extends from the backplate.

In accordance with another aspect of the disclosure, the frameplate and the backplate extend generally parallel to one another, and the bypass feature extends in inclined relation from the backplate.

In accordance with another aspect of the disclosure, the bypass feature extends transversely from the backplate, thereby minimizing the potential for deflection of the bypass feature if impacted by the pawl and/or ratchet.

In accordance with another aspect of the disclosure, the bypass feature extends to a free end arranged in side-by-side relation with a portion of the ratchet and the pawl, with a gap provided between the bypass feature and the ratchet and pawl, with the gap being sized to prevent the ratchet from moving out from the ratchet pivot plane when the ratchet impacts the bypass feature and the pawl from moving out from the pawl pivot plane when the pawl impacts the bypass feature.

In accordance with another aspect of the disclosure, the free end blocks the ratchet from moving out of the ratchet pivot plane and blocks the pawl from moving out of the pawl pivot plane while pawl is in the ratchet holding position.

In accordance with another aspect of the disclosure, a method of preventing inadvertent movement of a latch for a motor vehicle from moving out of a latched state, whereat a pawl holds a ratchet in a striker capture position, is provided. The method includes inhibiting movement of at least one of the ratchet out of a ratchet pivot plane about a ratchet pin and the pawl out of a pawl pivot plane about a pawl pin while the pawl is holding the ratchet in the striker capture position.

In accordance with another aspect of the disclosure, the method can further include supporting the ratchet pin and the pawl pin with a strength plate unit, and positioning a bypass feature adjacent at least one of the pawl pivot plane and the ratchet pivot plane, the bypass feature preventing at least one of the ratchet from moving out of the ratchet pivot plane and the pawl from moving out of the pawl pivot plane while the pawl is holding the ratchet in the striker capture position.

In accordance with another aspect of the disclosure, the method can further include providing the strength plate unit having a frameplate and a backplate, with the ratchet supported for pivotal movement within the ratchet pivot plane and the pawl supported for pivotal movement within the pawl pivot plane between the frameplate and the backplate, and extending the bypass feature toward the ratchet and the pawl from at least one of the frameplate and the backplate.

In accordance with another aspect of the disclosure, the method can further include providing the bypass feature as a monolithic piece of material with at least one of the frameplate and the backplate.

In accordance with another aspect of the disclosure, the method can further include providing the bypass feature as a bent piece of material of at least one of the frameplate and the backplate.

In accordance with another aspect of the disclosure, the method can further include arranging the frameplate and the backplate extending generally parallel to one another, with the bypass feature extending in inclined relation from at least one of the frameplate and the backplate.

In accordance with another aspect of the disclosure, the method can further include providing the bypass feature extending from the backplate.

In accordance with another aspect of the disclosure, the method can further include providing the bypass feature extending to a free end arranged in side-by-side relation with a portion of the ratchet and the pawl while the pawl is holding the ratchet in the striker capture position.

In accordance with another aspect of the disclosure, the method can further include proving a gap between the free end of the bypass feature and the ratchet and pawl, and sizing the gap to prevent the ratchet from moving out from the ratchet pivot plane when the ratchet impacts the free end of the bypass feature and preventing the pawl from moving out from the pawl pivot plane when the pawl impacts the free end of the bypass feature.

In accordance with another aspect of the disclosure, the method can further include providing the bypass feature being fixed to the backplate.

In accordance with another aspect of the disclosure, the method can further include providing the bypass feature as a deformed piece of material of the backplate.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 is a perspective view of a vehicle door equipped with a closure latch assembly;

FIG. 2 is a perspective view of the closure latch assembly of FIG. 1 showing a plurality of components associated with a ratchet and pawl type latch mechanism supported by a strength plate unit;

FIG. 3 is an enlarged partial perspective view of the closure latch assembly of FIG. 2 illustrating a ratchet/pawl bypass feature associated with the strength plate unit;

FIG. 4 is a close-up top view of the closure latch assembly of FIG. 2 illustrating ratchet/pawl bypass feature relative to the ratchet and pawl; and

FIG. 5 is a flow diagram illustrating a method of preventing inadvertent movement of a latch for a motor vehicle from moving out of a latched state, whereat a pawl holds a ratchet in a striker capture position.

### DETAILED DESCRIPTION OF PRESENTLY PREFERRED EMBODIMENTS

An example embodiment of a motor vehicle closure panel, a latch assembly will now be described more fully with reference to the accompanying drawings. To this end, the example embodiment of a latch assembly is provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiment may be embodied in many different forms, and that the example embodiment should not be construed to limit the scope of the present disclosure. In some parts of the example embodiment, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

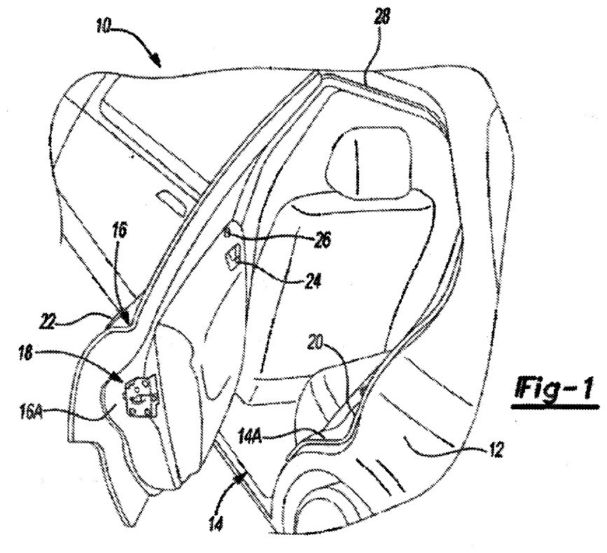

Now referring to FIG. 1, there is shown a motor vehicle 10, having a closure panel 16, shown as a swing door, by way of example and without limitation, for closing of an opening, such as a door way 14, formed in a vehicle body 12. A closure latch assembly, referred to hereafter as latch assembly 18, is provided on the door 16 to engage a striker 20 attached to the vehicle body 12 and close the door 16 in a latched state against a seal 28 provided on the body 12. The latch assembly 18 is shown provided at least on a shut face 16A of the door 16. An outside handle 22 may be used to release the latch assembly 18 either mechanically or electrically. Similarly, an inside handle 24 may be used to release the latch assembly 18. A lock 26 may be used to control the lock state of the latch assembly 18.

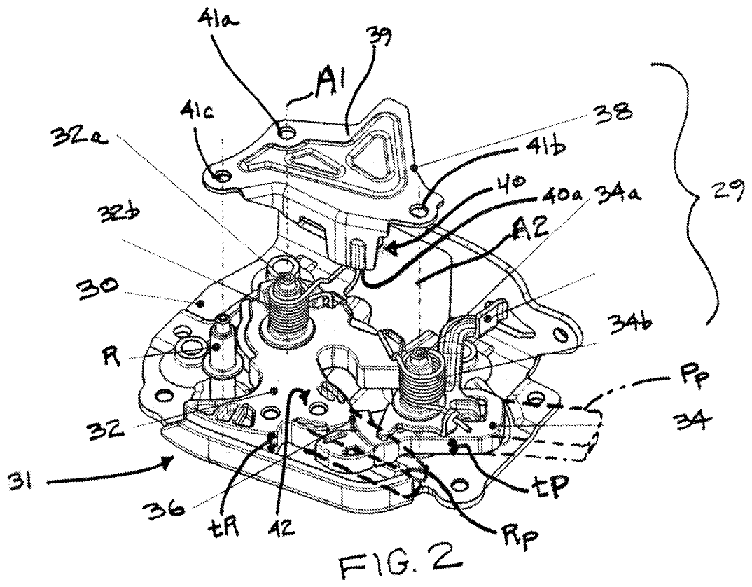

Now referring to FIG. 2, the latch assembly 18 is shown to generally include a strength plate unit 29 and a latch mechanism 31. The strength plate unit 29 includes a frameplate 30 and a backplate 38. The latch mechanism 31 includes a ratchet 32 and a pawl 34 both pivotally mounted to the frameplate 30 and the backplate 38. Ratchet 32 is supported by the strength plate unit 29 for pivotal movement between the fameplate 30 and backplate 38 about an axis A1 of a ratchet pin 32a within a ratchet pivot plane, also referred to as ratchet plane Rp (ratchet plane Rp is identified having a thickness equal to a thickness Rp of ratchet 32), between a striker release position, whereat the ratchet 32 is positioned to release the striker 20, and a striker capture position, whereat the ratchet 32 is positioned to retain the striker 20, with the ratchet 32 being biased by a ratchet biasing member 32b, such as torsion spring, by way of example and without limitation, toward the striker release position. Pawl 34 is supported by the strength plate unit 29 for pivotal movement between the fameplate 30 and backplate 38 about an axis A2 of a pawl pin 34a within a pawl pivot plane, also referred to as pawl plane Pp (pawl plane Pp is identified having a thickness tP equal to a thickness tp of pawl 34), between a ratchet holding position, whereat the pawl 34 is positioned to hold the ratchet 32 in the striker capture position, and a ratchet releasing position, whereat the pawl 34 is located to permit pivotal movement of the ratchet 32 within the ratchet pivot plane Rp to the striker release position, wherein the pawl 34 is biased by a pawl biasing member 34b, such as torsion spring, by way of example and without limitation, toward the ratchet holding position. In the non-limiting illustrated embodiment, ratchet plane Rp is coplanar with pawl plane Pp, with ratchet plane Rp and pawl plane Pp having equal, or substantially equal (meaning within about 1 mm or a fraction thereof, by way of example and without limitation) thickness tR, tP. Strength plate unit 29, as discussed further below, prevents movement of at least one or both of the ratchet 32 out of the ratchet pivot plane Rp and the pawl 34 out of the pawl pivot plane Pp while the pawl 34 is in the ratchet holding position, thereby preventing inadvertent movement of the latch assembly 18 from the latched state to an unlatched state, including while impacted by a sudden force, such as may be encountered in a crash condition of motor vehicle 10.

While in the ratchet holding position, the pawl 34 is configured to engage the ratchet 32 at a ratchet/pawl contact area 36, shown as having a thickness tR, tP to prevent the ratchet 32 from rotating to release the striker 20 and allow the door 16 to move to an opened position. The ratchet 32 and pawl 34 are configured for normal pivotal movement, with normal pivot movement meaning the pivotal movement is confined within their respective planes Rp, Pp, to allow or prevent the latch mechanism 31 from releasing the striker 20, depending on whether pawl 34 is in the ratchet holding position or the ratchet releasing position. The backplate 38, which is part of the strength plate unit 29, is shown to also be fixedly connected to the frameplate 30. In this non-limiting configuration, a generally planar body portion 39 of the backplate 38 includes three respective mounting bores 41a, 41b, 41c aligned to receive the end portions of ratchet rivet 32a, pawl rivet 34a, and a mounting rivet R, respectively.

A ratchet/pawl bypass feature, referred to hereafter as bypass feature 40, is formed to extend from strength plate unit 29 generally toward the ratchet 32 and the pawl 34 from at least one of the frameplate 30 and the backplate 38. Illustratively, bypass feature 40 is integrally formed with the frameplate 30 and is configured to extend perpendicular from the plane of the frameplate 30. For example, bypass feature 40 maybe formed from a stamping process applied to the frameplate 30 having the bypass feature 40 initially extending in the same plane as the frameplate 30 followed by a bending process to have the bypass feature 40 bent to extend in a different plane e.g. in a plane perpendicular to the frameplate 30. Bypass feature 40 extends to a free end 40a positioned adjacent, in side-by-side relation, with at least one of the pawl pivot plane Pp and the ratchet pivot plane Rp, such that free end 40a is immediately adjacent a sidewall portion of the ratchet 32 and/or the pawl 34, wherein the bypass feature 40 prevents at least one or both of the ratchet 32 from moving out of the ratchet pivot plane Rp and the pawl 34 from moving out of the pawl pivot plane Pp while the pawl 34 is in the ratchet holding position.

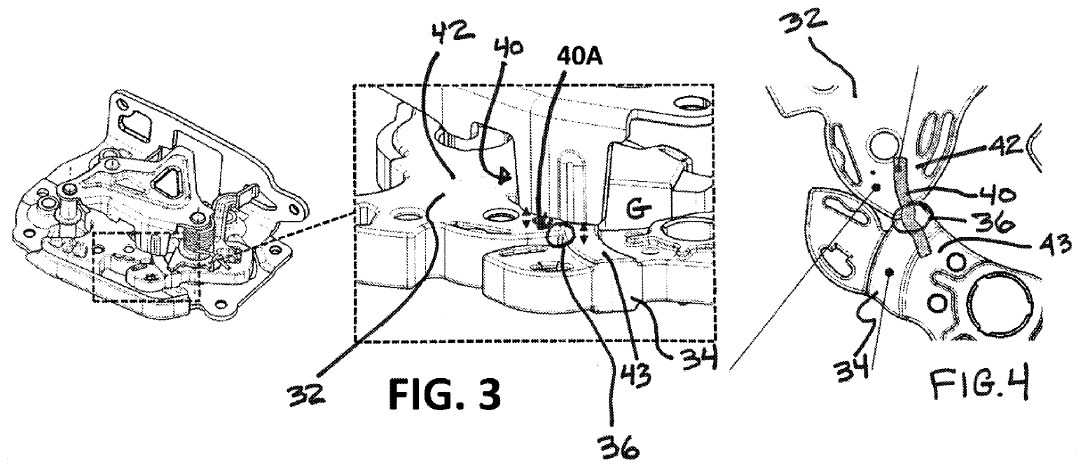

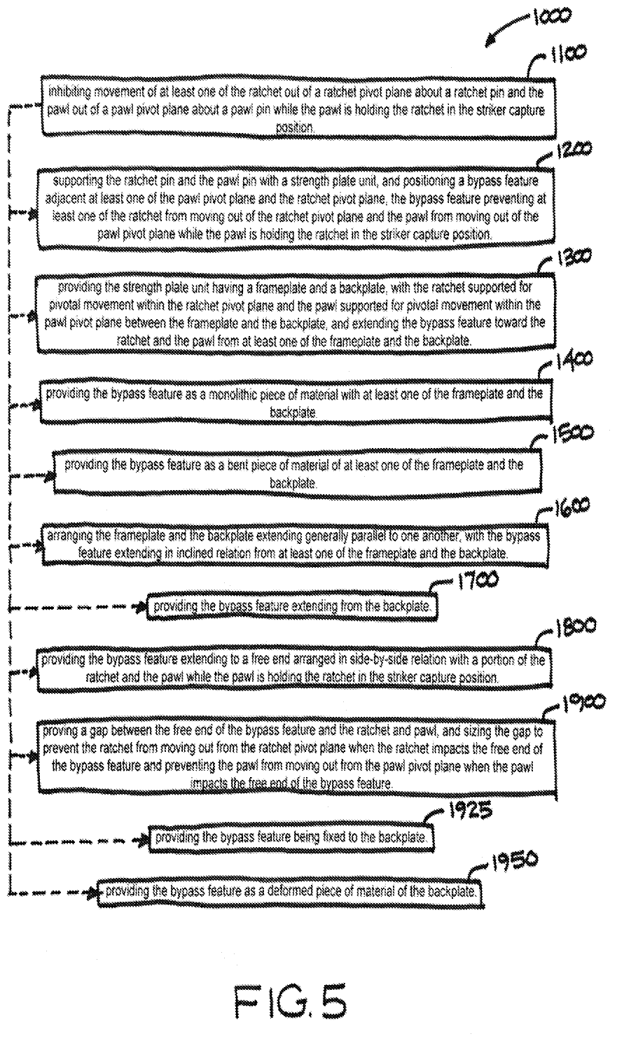

Now referring to FIG. 3 and FIG. 4, bypass feature 40 is shown to extend over both the ratchet 32 and the pawl 34 when viewed from a top view as shown in FIG. 4. Bypass feature 40 provides a blocking surface formed at the free end 40a, which is shown to be facing a planar sidewall surface 42 of the ratchet 32 and a planar sidewall surface 43 of the pawl 34, with free end blocking surface 42a being spaced from planar surfaces 42, 43 by a gap “G”, such as a millimeter or fraction of a millimeter, when the latch assembly 18 is normally operating in a non-sudden impact force condition, such as a non-crash condition. As such, free end 40a does not interfere with normal pivotal movement of pawl 32 and ratchet 34 as ratchet 32 and pawl 34 pivot within their respective planes Pp, Rp.

However, during an impact force on closure panel 16, such as in a crash condition, should deformation of the frameplate 30 result in a movement of the ratchet 32 and/or the pawl 34 toward the bypass feature 40, non-normal movement (any movement of ratchet 32 and/or pawl 34 out of their respective planes Rp, Pp) is hindered/prevented upon sidewall surfaces 42, 43 of ratchet 32 and/or pawl 34 bridging the gap G through contact of the blocking surface 41 with ratchet surface 42 and/or pawl surface 43. As such, the ratchet 32 and the pawl 34 do not lose contact from one another at ratchet/pawl contact area 36. Such non-normal movement of ratchet 32 and/or pawl 34 may include motion of the ratchet 32 and/or pawl 34 along an axial direction along their individual pivot axis, axis A1 and axis A2, respectively. The latch mechanism 31 of the latch assembly 18 therefore remains in a latched state, with pawl 34 remaining in a ratchet holding position with ratchet 32, despite non-normal movement of the ratchet 32 and/or pawl 34 caused by a sudden impact force, such as in a crash event.

In the non-limiting embodiment of latch assembly 18 illustrated, the bypass feature 40 is shown fixed to and extending from the body portion 39 of backplate 38 of strength plate unit 29. The bypass feature 40 is further shown formed as a monolithic piece of material with the backplate 38, such as by being formed as a bent piece of material of the backplate 38, way of example and without limitation. It is contemplated herein that bypass feature 40 could be formed as a separate piece of material that is subsequently fixed to backplate 38 and/or frameplate 30, if desired, thought this would likely require more costly processes than illustrated. The frameplate 30 and the backplate 38 extend generally parallel to one another, with ratchet 32 and pawl 34 capture for pivotal movement with their respective planes Rp, Pp therebetween, with the bypass feature 40 extending in inclined relation from the backplate 38, and in a non-limiting embodiment, extending in transverse relation from the body portion 39 of backplate 38. With bypass feature 40 extending in transverse relation to body portion 39, a maximum impact force from ratchet 32 and/or pawl 34 can be encountered without bypass feature 40 being deflected, and thus, pawl 34 is assured of maintaining ratchet 32 in the striker capture position, thereby preventing inadvertent release of latch assembly 18 to the unlatched state.

In accordance with another aspect of the disclosure, a method 1000 of preventing inadvertent movement of a latch 18 for a motor vehicle 10 from moving out of a latched state, whereat a pawl 34 holds a ratchet 32 in a striker capture position, is provided. The method 1000 includes a step 1100 of inhibiting movement of at least one of the ratchet 32 out of a ratchet pivot plane Rp about a ratchet pin 32a and the pawl 34 out of a pawl pivot plane Pp about a pawl pin 34a while the pawl 34 is holding the ratchet 32 in the striker capture position.

The method 1000 can further include a step 1200 of supporting the ratchet pin 32a and the pawl pin 34a with a strength plate unit 29, and positioning a bypass feature 40 adjacent at least one of the pawl pivot plane Pp and the ratchet pivot plane Rp, the bypass feature 40 preventing at least one of the ratchet 32 from moving out of the ratchet pivot plane Rp and the pawl 34 from moving out of the pawl pivot plane Pp, while the pawl 34 is holding the ratchet 32 in the striker capture position.

The method 1000 can further include a step 1300 of providing the strength plate unit 29 having a frameplate 30 and a backplate 38, with the ratchet 32 supported for pivotal movement within the ratchet pivot plane Rp and the pawl 34 supported for pivotal movement within the pawl pivot plane Pp between the frameplate 30 and the backplate 38, and extending the bypass feature 40 toward the ratchet 32 and the pawl 34 from at least one of the frameplate 30 and the backplate 38.

The method 1000 can further include a step 1400 of providing the bypass feature 40 as a monolithic piece of material with at least one of the frameplate 30 and the backplate 38.

The method 1000 can further include a step 1500 of providing the bypass feature 40 as a bent piece of material of at least one of the frameplate 30 and the backplate 38.

The method 1000 can further include a step 1600 of arranging the frameplate 30 and the backplate 38 extending generally parallel to one another, with the bypass feature 40 extending in inclined relation from at least one of the frameplate 30 and the backplate 38.

The method 1000 can further include a step 1700 of providing the bypass feature 40 extending from the backplate 38.

The method 1000 can further include a step 1800 of providing the bypass feature 40 extending to a free end 40a arranged in side-by-side relation with a portion of the ratchet 32 and the pawl 34, while the pawl 34 is holding the ratchet 32 in the striker capture position.

The method 1000 can further include a step 1900 of proving a gap G between the free end 40a of the bypass feature 40 and the ratchet 32 and pawl 34, and sizing the gap G to prevent the ratchet 32 from moving out from the ratchet pivot plane Rp when the ratchet 32 impacts the free end 40a of the bypass feature 40 and preventing the pawl 34 from moving out from the pawl pivot plane Pp when the pawl 34 impacts the free end 40a of the bypass feature 40.

The method 1000 can further include a step 1925 of providing the bypass feature 40 being fixed to the backplate 38.

The method 1000 can further include a step 1950 of providing the bypass feature 40 as a deformed piece of material of the backplate 38.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A closure latch assembly for a motor vehicle, comprising:
a strength plate unit;
a ratchet supported by the strength plate unit for pivotal movement about a ratchet pin within a ratchet pivot plane between a striker release position, whereat the ratchet is positioned to release a striker, and a striker capture position, whereat the ratchet is positioned to retain the striker, with the ratchet being biased toward the striker release position;
a pawl supported by the strength plate unit for pivotal movement about a pawl pin within a pawl pivot plane between a ratchet holding position, whereat the pawl is positioned to hold the ratchet in the striker capture position, and a ratchet releasing position, whereat the pawl is located to permit pivotal movement of the ratchet within the ratchet pivot plane to the striker release position, wherein the pawl is biased toward the ratchet holding position;
wherein the strength plate unit prevents movement of at least one of the ratchet out of the ratchet pivot plane and the pawl out of the pawl pivot plane while the pawl is in the ratchet holding position.

2. The closure latch assembly of claim 1, wherein the strength plate unit has a bypass feature positioned adjacent at least one of the pawl pivot plane and the ratchet pivot plane, the bypass feature preventing at least one of the ratchet from moving out of the ratchet pivot plane and the pawl from moving out of the pawl pivot plane while the pawl is in the ratchet holding position.

3. The closure latch assembly of claim 2, wherein the strength plate unit includes a frameplate and a backplate, wherein the ratchet and the pawl are supported for pivotal movement between the frameplate and the backplate, and the bypass feature is formed extending generally toward the ratchet and the pawl from at least one of the frameplate and the backplate.

4. The closure latch assembly of claim 3, wherein the bypass feature is formed as a monolithic piece of material with at least one of the frameplate and the backplate.

5. The closure latch assembly of claim 4, wherein the bypass feature is formed as a bent piece of material of at least one of the frameplate and the backplate.

6. The closure latch assembly of claim 3, wherein the bypass feature is fixed to and extends from the backplate.

7. The closure latch assembly of claim 6, wherein the frameplate and the backplate extend generally parallel to one another, the bypass feature extending in inclined relation from the backplate.

8. The closure latch assembly of claim 7, wherein the bypass feature extends transversely from the backplate.

9. The closure latch assembly of claim 3, wherein the bypass feature extends to a free end arranged in side-by-side relation with a portion of the ratchet and the pawl.

10. The closure latch assembly of claim 9, wherein the free end blocks the ratchet from moving out of the ratchet pivot plane and blocks the pawl from moving out of the pawl pivot plane while pawl is in the ratchet holding position.

11. A method of preventing inadvertent movement of a latch for a motor vehicle from moving out of a latched state, whereat a pawl holds a ratchet in a striker capture position, comprising:
inhibiting movement of at least one of the ratchet out of a ratchet pivot plane about a ratchet pin and the pawl out of a pawl pivot plane about a pawl pin while the pawl is holding the ratchet in the striker capture position.

12. The method of claim 11, further including supporting the ratchet pin and the pawl pin with a strength plate unit, and positioning a bypass feature adjacent at least one of the pawl pivot plane and the ratchet pivot plane, the bypass feature preventing at least one of the ratchet from moving out of the ratchet pivot plane and the pawl from moving out of the pawl pivot plane while the pawl is holding the ratchet in the striker capture position.

13. The method of claim 12, further including providing the strength plate unit having a frameplate and a backplate, with the ratchet supported for pivotal movement within the ratchet pivot plane and the pawl supported for pivotal movement within the pawl pivot plane between the frameplate and the backplate, and extending the bypass feature toward the ratchet and the pawl from at least one of the frameplate and the backplate.

14. The method of claim 13, further including providing the bypass feature as a monolithic piece of material with at least one of the frameplate and the backplate.

15. The method of claim 14, further including providing the bypass feature as a bent piece of material of at least one of the frameplate and the backplate.

16. The method of claim 13, further including arranging the frameplate and the backplate extending generally parallel to one another, with the bypass feature extending in inclined relation from at least one of the frameplate and the backplate.

17. The method of claim 16, further including providing the bypass feature extending from the backplate.

18. The method of claim 16, further including providing the bypass feature extending to a free end arranged in side-by-side relation with a portion of the ratchet and the pawl while the pawl is holding the ratchet in the striker capture position.

19. The method of claim 18, further including proving a gap between the free end of the bypass feature and the ratchet and pawl, and sizing the gap to prevent the ratchet from moving out from the ratchet pivot plane when the ratchet impacts the free end of the bypass feature and preventing the pawl from moving out from the pawl pivot plane when the pawl impacts the free end of the bypass feature.

20. The method of claim 20, further including providing the bypass feature being fixed to the backplate.
